(19) United States
(12) Patent Application Publication
(10) Pub. No.: US 2005/0076161 A1
(43) Pub. Date: Apr. 7, 2005

(54) Input system and method

(76) Inventors: Amro Albanna, Riverside, CA (US); Rowena Albanna, Riverside, CA (US); Xuejun Tan, Riverside, CA (US); Kirby Clark Dotson, Aliso Viejo, CA (US); David Ralph Addington, Lake Elsinore, CA (US)

Correspondence Address: Steven B. Pokotilow;Stroock & Stroock & Lavan LLP, 180 Maiden Lane, New York, NY, 10038, US

(21) Appl. No.: 10/741,308

(22) Filed: Dec. 19, 2003

Related U.S. Application Data
(60) Provisional application No. 60/508,466, filed on Oct. 3, 2003.

(51) Int. Cl. G06F 3/00

(52) U.S. Cl. 710/15

(57) ABSTRACT

Systems and methods for measuring a golf swing, and more particularly to systems and methods for converting movement of an object from a first format into input device data of a second format that a computer application is configured to receive, are described. Certain embodiments of the invention include: a sensor unit including one or more sensors configured to measure movement of the object in one or more directions and create a signal representative of the movement of the object in a first format, a transmitter configured to communicate the signal, and a user station having driver software configured to receive the signal, convert the signal into simulated input device data having the second format, and provide the simulated input device data to the computer application.

### CROSS-REFERENCE TO RELATED APPLICATIONS

This Application claims the benefit of U.S. Provisional Application Ser. No. 60/508,466, filed on Oct. 3, 2003, entitled VIDEO GAME INPUT SYSTEM AND METHOD OF PROVIDING SAME, hereby incorporated by reference.

A portion of the disclosure of this patent document contains material which is subject to copyright or mask work protection. The copyright or mask work owner has no objection to the facsimile reproduction by any one of the patent document or the patent disclosure, as it appears in the Patent and Trademark Office patent file or records, but otherwise reserves all copyright or mask work rights whatsoever.

### BACKGROUND OF THE INVENTION

1. Field of the Invention

The present invention relates generally to a video game input system, and, more particularly, to a system and method for converting movement of a moving object into input device data, such as mouse controller input data, to a video game or computer application.

2. Description of Related Art

Video games are a popular form of entertainment. Video games often use input devices, such as a mouse, joystick, keyboard, or other game controller, to receive the input data from the user that is necessary to control the game characters and features of the game. When playing a sports video game, it is desirable to the user to feel like they are actually playing the sport that is the subject of the video game. The aforementioned input devices are generic to all types of video games and do not give the user such a realistic feeling of playing a sport. Accordingly, a need exists for a method and system that better captures the realistic feeling of actually playing the sport that is the subject of a video game when the user is providing input to control the game characters and features of the video game.

3. Summary of the Invention

The foregoing as well as other, needs are satisfied by the present invention. According to certain embodiments, systems and methods for converting movement of a moving object into input device data are disclosed.

One embodiment of the invention is directed to a system for use with a computer application configured to respond to first input device data from a first input device, the first input device having a first format. This embodiment of the present invention includes: a second input device, different than the first input device, the second input device including one or more sensors configured to measure movement of an object and creating second input device data representative of the movement of the object, the second input device data having a second format different than the first format; and a processor configured to convert the second input device data into simulated first input device data, the simulated first input device data having the first format, the processor further configured to provide the simulated first input device data to the computer application, thereby simulating the first input device with the second input device.

Another embodiment of the invention is directed to a system for converting movement of an object from a first format into input device data of a second format that a computer application is configured to receive. This embodiment of the present invention includes a sensor unit including: one or more sensors configured to measure movement of the object in one or more directions and create a signal representative of the movement of the object in a first format; a transmitter configured to communicate the signal; and a user station having driver software configured to receive the signal, convert the signal into simulated input device data having the second format, and provide the simulated input device data to the computer application.

Yet another embodiment of the invention is directed to a method of providing input to a computer application configured to receive first input device data having a first format. This embodiment of the present invention includes: measuring movement of an object in one or more directions; creating second input device data representative of the movement of the object, the second input device data having a second format different than the first format; converting the second input device data into simulated first input device data, the simulated first input device data having the first format; and providing the simulated first input device data to the computer application, thereby simulating the first input device with the second input device.

Yet another embodiment of the invention is directed to a system of providing input to a computer application configured to receive first input device data having a first format. This embodiment of the present invention includes: means for measuring movement of an object in one or more directions; means for creating second input device data representative of the movement of the object, the second input device data having a second format different than the first format; means for converting the second input device data into simulated first input device data, the simulated first input device data having the first format; and means for providing the simulated first input device data to the computer application, thereby simulating the first input device with the second input device.

Yet another embodiment of the invention is directed to a method for replicating first input device data of a first input device, the first input device data having a first format, to a computer application, to control movement of a graphical representation of an object. This embodiment of the present invention includes: measuring movement of the object with a second input device; creating an electronic signal representative of the movement of the object, the electronic signal having a second format different from the first format; translating the electronic signal into replicated first input device data having the first format; and making the replicated first input device data available to the computer application, thereby replicating first input device data from the first input device with replicated first input device data for the second input device.

Yet another embodiment of the invention is directed to a computer readable medium comprising code for configuring a processor. This embodiment of the present invention includes: providing simulated input device data to a computer application, the computer application configured to control a graphical representation of an object in response to input device data; and translating a signal into the simulated input device data, the signal representing physical movement of the object, the signal having a signal format incompatible with the computer application and the simulated input device data compatible with the computer application, thereby simulating the input device data.

The invention will next be described in connection with certain exemplary embodiments; however, it should be clear to those skilled in the art that various modifications, additions, and subtractions can be made without departing from the spirit or scope of the claims.

### BRIEF DESCRIPTION OF THE DRAWINGS

The following drawing figures, which are included herewith and form a part of this application, are intended to be illustrative examples and not limiting of the scope of the present invention.

FIG. 1 is a schematic illustrating the components and flow of data according to one embodiment of the present invention.

FIG. 2 is an illustration of the layout of the accelerometers of the sensor unit according to one embodiment of the present invention.

FIG. 3 is a flowchart illustrating the process for using a device and software to play a golf video game according to one embodiment of the present invention.

FIG. 4 is a flowchart illustrating the process for simulating mouse controller movement according to one embodiment of the present invention.

FIG. 5 is a flowchart illustrating the process for determining whether the sensor unit is in static status of the device according to one embodiment of the present invention.

FIGS. 6(a)-6(d) are graphs illustrating the mapping of the angle data to the correct quadrants according to one embodiment of the present invention.

FIGS. 7(a)-7(c) are flowcharts illustrating the process for transformation of the unfiltered angle data to filtered angle data according to one embodiment of the present invention.

FIG. 8 is pseudocode illustrating the process for transformation of raw angle data to correct quadrant angle data according to one embodiment of the present invention.

FIG. 9 is graph illustrating an example of raw angle data, transformed angle data, and raw acceleration data for a three-quarter fast swing according to one embodiment of the present invention.

FIG. 10(a)-10(c) is pseudocode illustrating the process for transforming the angle change of a golf club swing into mouse controller movement data according to one embodiment of the present invention.

FIG. 11 is pseudocode illustrating the process for converting exceptionally large swing data into mouse controller movement data that can be understood by a video game according to one embodiment of the present invention.

### DETAILED DESCRIPTION OF CERTAIN EMBODIMENTS

Certain embodiments of the present invention will now be described in greater detail with reference to the aforementioned figures.

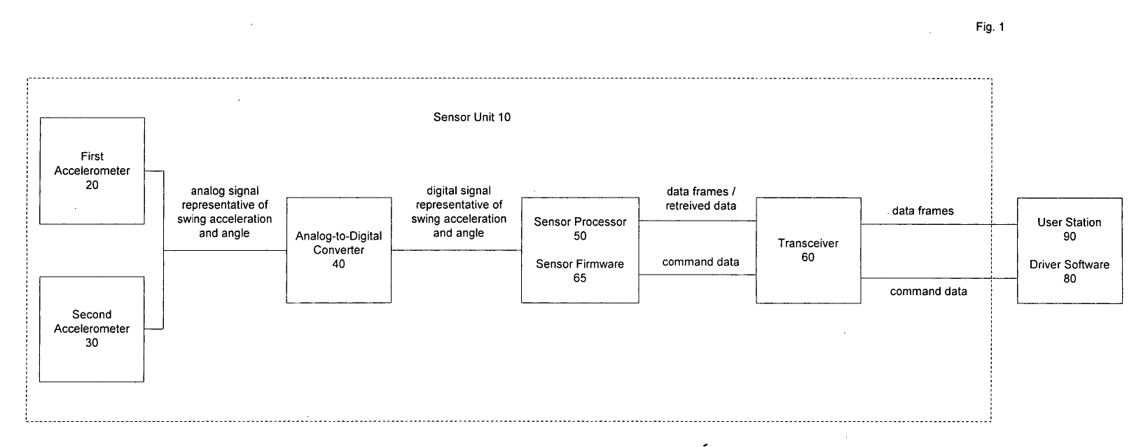

FIG. 1 is a workflow diagram illustrating the components and flow of data according to one embodiment of the present invention. This embodiment of the invention includes: a first sensor 20, a second sensor 30, an analog-to-digital converter 40, a sensor processor 50, a transmitter 60, sensor firmware 65, driver software 80 and a user station 90. In the present embodiment, the first sensor 20 and second sensor 30 are each accelerometers (first accelerometer 20 and second accelerometer 30, collectively, the accelerometers 20). In alternate embodiments, the other types of sensors may be used, such as rate gyros, so as to extract rotational motion in addition to translational motion.

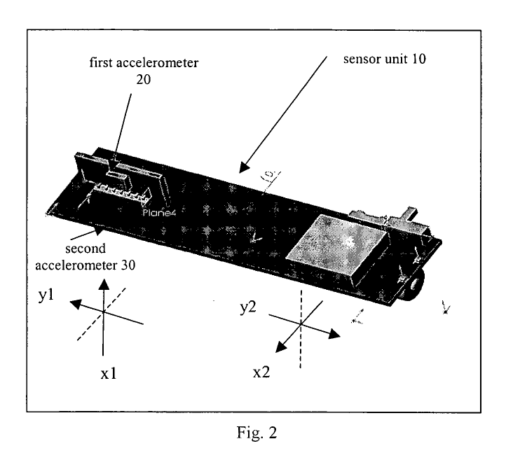

In the present embodiment, as shown in FIG. 2, the accelerometers 20, analog-to-digital converter 40, the sensor processor 50, the transmitter 60, and the sensor firmware 65 are housed in a single sensor unit 10. The sensor unit 10 attaches to a movable object, which is a golf club 70 in this embodiment. The sensor unit 10 is communicatively coupled to the user station 90, via any wired or wireless transmission, such as a serial connector, USB cable, wireless local area network and the like, utilizing essentially any type of communication protocol, such as Bluetooth Ethernet, and the like. Although two-way communication is not required for all embodiments, the transmitter 60 is a transceiver 60 configured to allow two-way communication of data between the sensor unit 10 and the user station 90 (data can be sent from the sensor unit 10 to the user station 90 and data can be sent from the user station 90 to the sensor unit 10). The sensor firmware 65 is configured to listen for command data sent from the user station 90 to the sensor unit 10, which requests the sensor unit 10 to send data to the user station 90. Additionally, the aforementioned components included in the sensor unit 10 may be coupled to one another via any wired or wireless transmission, utilizing essentially any type of communication protocol.

In alternate embodiments, the sensor unit 10 and a dongle unit, each house a wireless transceiver 60. The dongle unit may plug into the USB or serial port of the user station 90 to allow wireless two-way communication of data between the sensor unit 10 and the user station 90. Additionally, the sensor unit 10 may house a transmitter 60 and the dongle unit may house a receiver to allow wireless one-way communication of data from the sensor unit 10 to the user station 90.

The user station 90 is a computing device—a personal computer (PC) having a mouse in the present embodiment, although in alternate embodiments other processors may be used, such as a personal digital assistant (PDA), hand-held game device, web-enabled cellular telephone, laptop computer, home entertainment system (such as those offered by Nintendo of America Inc. and Sega Corporation) and the like, having the ability to accept input data from a mouse controller and having the ability to run a video game or computer application, such as a training simulation, requiring mouse controller input data. Additionally, in alternate embodiments, the user station 90 may have associated therewith any other type of input device, such as a joystick, paddle, keyboard, or any other type of game controller input and the like, and may have the ability to run a video game or computer application requiring input device data from any of the aforementioned input devices and the like.

The driver software 80 running on the user station 90 is configured to process the digital signal representative of the movement of a moving object received from the sensor unit 10 and convert the digital signal into input device data that can be used to control the movement of game character in the video game or computer application running on the user station 90. In alternate embodiments, the computer application may reside on a machine other than the user station and be accessible to the user of the system via a network, such as the Internet, local area network, cable television, satellite television, and the like.

In the present embodiment, the moving object is a golf club 70 and the digital signal received by the driver software 80 from the sensor unit 10 is a digital signal representative of the acceleration and angle of a swinging club 70. In the present embodiment, the digital signal received from the sensor unit 10 is converted into mouse controller input data. However, in alternate embodiments, the digital signal received from the sensor unit 10 may be converted into other types of input device data, such as joystick, paddle, keyboard, or any other type of game controller input data, and the like, that may be used to control the movement of game character in the video game or computer application running on the user station 90. In the present embodiment, the driver software 80 has a user interface associated therewith for communicating visually and/or audibly with the user, including, but not limited to, receiving user inputs, configuring parameters, logging data, displaying captured data, selecting a port from which to read data, and setting a mode for a left-handed or right-handed golfer.

The system of the present embodiment is used to provide input to any commercial off-the-shelf computer or other video game or computer application capable of using data from an input device, including those simulating the sport of golf, such as that offered by Microsoft Corporation under the trademark LINKS2003, by Electronic Arts Inc. under the trademark TIGER WOODS PGA TOUR 2003, as well as those simulating other sports and scenarios, such as baseball, tennis, soccer, volleyball and hockey. In the present embodiment the sensor unit 10 is attached to a golf club 70. However, in alternate embodiments, the sensor unit 10 may be attached to any other type of moveable object including, a piece of sporting equipment (such as a baseball bat, tennis racket, hockey stick) or may be attached to the user themselves (such as the user's arm or leg, via an arm or leg band having a material, such as velcro) to measure data to convert to mouse controller movement to play a video game or computer application, such as a training simulation.

More specifically, in the present embodiment, the system is designed to allow a user to capture a more realistic feeling of playing golf with the LINKS2003 golf game, by choosing to use a golf club 70 as the input device to a golf video game, instead of the mouse controller, to control the movement of the game characters of the video game, such as the swing of the golf club 70 and, consequently, the movement of the golf ball (path, direction, speed, etc.). The sensor unit 10 attached to the golf club 70 measures the acceleration and angle of the user's swing and produces mouse controller input data representative of the user's swing to be utilized by the video game to control the aforementioned game characters. Thus, the sensor unit 10 is an input device that is separate and distinct from the input device—the mouse—that the video game is designed to respond to. By translating or converting the sensor output signal into the format of the mouse controller, the system replicates or simulates the mouse controller data. Notably, when the format of the translated sensor signal is described to be the same as that of the controller input data, such as mouse controller data, it is to be understood that exact identity of format need not be accomplished, as the description is meant to encompass identity only to the degree required for the user station (and any necessary software) to use the translated sensor signal. Because the system functions independently of the video game and the conversion to mouse controller input data occurs prior to the input of swing data to the video game, the video game receives the mouse controller input data unaware of use of the golf club 70, sensor unit 10, or any prior conversion of data. In this manner, the system of the present embodiment may be utilized for any golf video game that is designed to use mouse controller input data, without the necessity of any additional coding to the video game. In alternate embodiments, however, the translation of movement data into mouse, or other controller, input data may be incorporated into the applicable video game or other computer application.

Having generally described the components of the present embodiment, each component will now be described in greater detail.

As illustrated, the sensor unit 10 houses the first and second accelerometers 20, the analog-to-digital converter 40, the sensor processor 50, and the transceiver 60. The sensor unit 10 is attachable to the shaft of any conventional golf club 70 by any known or developed means, including those permanently and temporarily attached. In the present embodiment, a Velcro hook on the curved bottom of the sensor unit 10 is wrapped in a Velcro loop on the shaft of the club 70 to attach the sensor unit 10 to the club 70. Another velcro hook/loop combination is used to further secure the sensor unit 10 onto the shaft of the club 70. In alternate embodiments, the sensor unit 10 is molded plastic having deformable clips molded therein for receiving the golf club 70. In further alternate embodiments, the means for attaching the sensor unit 10 to the golf club 70 may be clasps, straps, loops, rings, fasteners, velcro, and the like. Preferably, the sensor unit 10 is attached near the bottom third of the club 70 to be close to head of the club 70, which is the point at which the most accurate acceleration and angle of the user's swing can be measured. However, in alternate embodiments, the sensor unit 10 is housed directly within the moveable equipment, such as within a golf club 70, hockey stick, or tennis racket.

As shown in FIG. 2, the sensor unit 10 includes a first accelerometer 20 and a second accelerometer 30, each configured to measure acceleration data and angle data in two directions. In the present embodiment, the dual-axis accelerometers offered by Analog Devices Inc. under model number ADXL202 are used, although in other embodiments other types of accelerometers may be used, such as the ADXL210. The first accelerometer 20 is configured to measure acceleration data and angle data in the x1 and y1 axes. The second accelerometer 30 is configured to measure acceleration data and angle data in the x2 and y2 axes. In the present embodiment, the accelerometers 20 are positioned orthogonal to each other, although other configurations are possible. The accelerometers 20 should also be positioned as close as possible to each other to achieve the most accurate measurement of acceleration and angle data.

The analog-to-digital converter 40 is communicatively coupled to the accelerometers 20 and converts the analog signal representative of the acceleration and angle of the swing produced by the accelerometers 20 to a digital signal representative of the acceleration and angle of the swing.

The sensor processor 50 is communicatively coupled to the analog-to-digital converter 40 to receive the digitized acceleration and angle data. This sensor processor receives the data, assembles it into data frames and communicates it to the transceiver 60. Each data frame contains measurements of acceleration data and angle data at a specific point in time during a swing.

The transceiver 60 is communicatively coupled to the sensor processor 50 and the sensor firmware 65 communicates the digital signal representative of the acceleration and angle of the swinging club 70 to the user station 90. The transceiver 60 may also receive command data from the user station 90.

The sensor firmware 65 is communicatively coupled to the transceiver 60 and sensor processor 50 and continuously listens for command data sent from the user station 90 to the sensor unit 10 (when turned on), which requests the sensor unit 10 to send data to the user station 90, such as a request for calibration data (described later in the application). When the sensor firmware 65 recognizes that command data is being received by the sensor unit 10, via the transceiver 60, the assembly and transmission of data frames by the sensor processor 50 to the sensor unit 10 is temporarily halted, to allow the requested information to be sent to the user station 90.

In the present embodiment, the sensor unit 10 (when turned on) continuously communicates the acceleration data and angle data in the form of data frames to the data buffer of the serial port located in the operating system on the user station 10. The data frames are communicated to the data buffer at a rate of 100 data frames per second, although in alternate embodiments that rate may be higher or lower. The driver software 80 retrieves the data frames stored in the data buffer in the form of data blocks. Each data block includes one or more data frames. The number of data frames in each data block depends on the driver software 80, operating system, and the user station 90. Each data frame consists of an array of data containing the following values:
acc_x1, acc_y1, acc_x2, acc_y2, ang_x1, ang_y1, ang_x2, ang_y2

In each data frame, the term “acc” represents acceleration, the term “ang” represents angle, the numbers 1 and 2 represent the corresponding accelerometer 20, and the letters x and y represent the corresponding axis of measurement (for example, variable acc_x1 represents the acceleration data in the x axis for the first accelerometer 20.)

In each data frame, the acceleration data for acc_x1, acc_y1, acc_x2, and acc_y2 is measured directly from the corresponding accelerometers 20. Each accelerometer 20 may also be used as a dual axis tilt sensor to measure angle data. In each data frame, the angle data for ang_x1, ang_y1, ang_x2, and ang_y2 is computed by the sensor firmware 65 residing on the sensor unit 10 using data received from the corresponding accelerometer 20. In the present embodiment, the angle data is output by the accelerometer 20 encoded as Pulse Width Modulation (“PWM”) data, although different accelerometers may output the data differently.

The accelerometers 20 use the force of gravity as an input vector to determine orientation of an object in space. An accelerometer is most sensitive to tilt when its sensitive axis is perpendicular to the force of gravity (parallel to the Earth's surface). At this orientation, sensitivity to changes in tilt is highest. The reference point for the angle of the club 70 is calibrated at the factory, preferably to be 1 g where g represents a unit of gravity (−1 g when parallel to the Earth's surface in an opposite orientation).

In general, when each accelerometer 20 is oriented on an axis parallel to the force of gravity, near its 1 g or −1 g reading, the change in calculated angle per degree of tilt is negligible. As each accelerometer's 20 orientation approaches an axis perpendicular to the force gravity, the relative sensitivity of the calculated angle per degree of tilt becomes greater. By utilizing the change in output acceleration for x and y axes of each accelerometer 20, it is possible to calculate the angle data for x and y axes of each accelerometer 20 and the degree of orientation of the golf club 70 with respect to the Earth's surface. The relationship between the output acceleration and the degree of orientation for accelerometers 20 are typically known, and, if not, can be determined by routine testing. It has been found that in the present embodiment, generally, the angle data is useful only when the sensor unit 10 is in static status, because when the sensor unit 10 is in motion, the angle data is inaccurate because the movement is based on a combination of gravity and the user-induced motion. Accordingly, the present invention utilizes angle data primarily when the club 70 is in a static or slow moving state.

In the present embodiment, the driver software 80 receives the calibration data from the particular sensor unit 10 being used with the system in order to more accurately convert the acceleration and angle data received from the sensor unit 10 into mouse controller movement data. The driver software 80 running on user station 90 sends a request for the retrieval of calibration data to the sensor unit 10 (at any time when the sensor unit is turned on). The sensor firmware 65, listening for command data, recognizes the request for the retrieval of calibration data from the user station 90. The sensor firmware 65 instructs the sensor processor 50 to temporarily halt the assembly and continuous transmission of data frames to the user station 90 and retrieves the calibration data for each sensor 20 requested by the driver software 80. The calibration data for each sensor 20 is sent, via the transceiver 60, to the driver software 80 and used by the driver software 80 to determine the proper mouse controller movement data. Without the proper calibration data for each sensor 20, the driver software 80 would not have a proper reference point at which to correctly interpret the acceleration and angle data from the sensors and would result in simulating mouse movement that is not properly representative of the user's swing.

Additionally, in alternate embodiments, a data frame may be organized in a variety of manners having one or more of the aforementioned variables or additional variables to allow for the storage of angle and/or acceleration data and/or additional measurement data that may be calculated by other types of sensors, such as turn rate and direction, as calculated by a rate gyro.

Persons of skill in the art will recognize that, although the above-referenced system components are discussed and shown as being housed in a singular sensor unit 10, as a matter of design choice, any number of system components may be housed in separate units or combined into one or more system components or units to be utilized within the scope of the present invention. In alternate embodiments, multiple sensors or sensor units may be spaced at different points along the moveable object to better measure the position of the moveable object. Also, in alternate embodiments, the accelerometers 20 are configured to directly output a digital signal, obviating the need for an analog-to-digital converter 40. Additionally, although in the present embodiment the sensor unit 10 attaches to a golf club 70, in alternate embodiments, the sensor unit 10 may attach to any other type of moveable equipment that could be used as an input device for a user station, including, but not limited to, a baseball bat, a hockey stick, tennis racket, and the like. Further, although in the present embodiment the data received from the sensor unit 10 is converted to mouse controller input data, it should be understood that the data received from the sensor unit 10 may be converted into any type of input device data that is utilized by a video game or simulation on a user station 90.

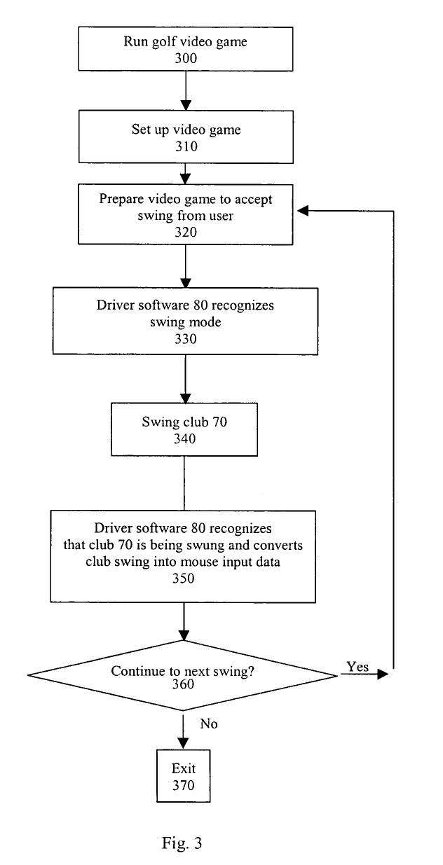

Having described the components of the present embodiment, the operation thereof will now be described in greater detail. The process for using a device and software to play a golf video game according to one embodiment of the present invention will now be described with reference to FIG. 3.

In step 300, the user loads or runs a golf video game, such as those identified above, and the driver software 80 on a user station 90. In step 310, the user sets up the video game according to the game's instructions, such as configuring the game to play in real-time swing mode in LINKS2003. In step 320, the user starts the video game, preparing the game to accept input data to control the movement of the video game characters.

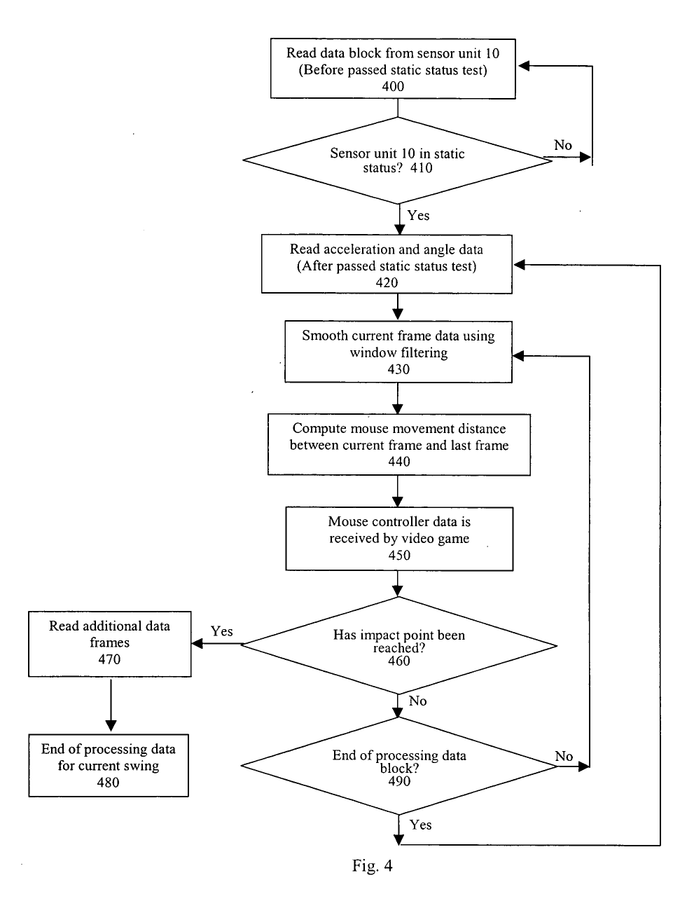

In step 330, driver software recognizes the type of swing mode that has been selected by the user on the video game, for example (1) full swing, (2) chipping, or (3) putting, to configure the proper conversion of acceleration and angle data into mouse controller input data for the swing. In many golf video games, the amount of mouse controller movement necessary to hit the golf ball a certain distance will vary based upon the type of swing mode. For example, a long putt may require a relatively large amount of mouse controller movement similar to a long drive on a video game; whereas a long putt may require only slight club movement as compared to a drive using a golf club 70. Therefore, in certain embodiments, the driver software 80 accounts for this change by being aware of the proper conversion rate of the acceleration and angle data of the user's swing into mouse controller input data to be used by the particular video game. In step 340, the user swings the golf club 70, having the attached sensor unit 10 of the present embodiment. In step 350, the driver software 80 recognizes that the golf club 70 is being swung by the user, via the process described in greater detail herein in FIG. 4. In step 360, the user determines whether to continue to the next swing as is typical in playing the game. If the user determines to continue to the next swing, the processes returns to the user preparing the system to accept the next swing input (step 320). If the user determines not to continue to the next swing (for example, where the game has ended or the user has chosen to quit the game), the process ends (step 370).

As noted above, the driver software 80 converts the accelerometer data into mouse controller input data for simulating a user's movement of the mouse. The process for simulating mouse controller movement according to one embodiment of the present invention will now be described in greater detail with reference to FIG. 4.

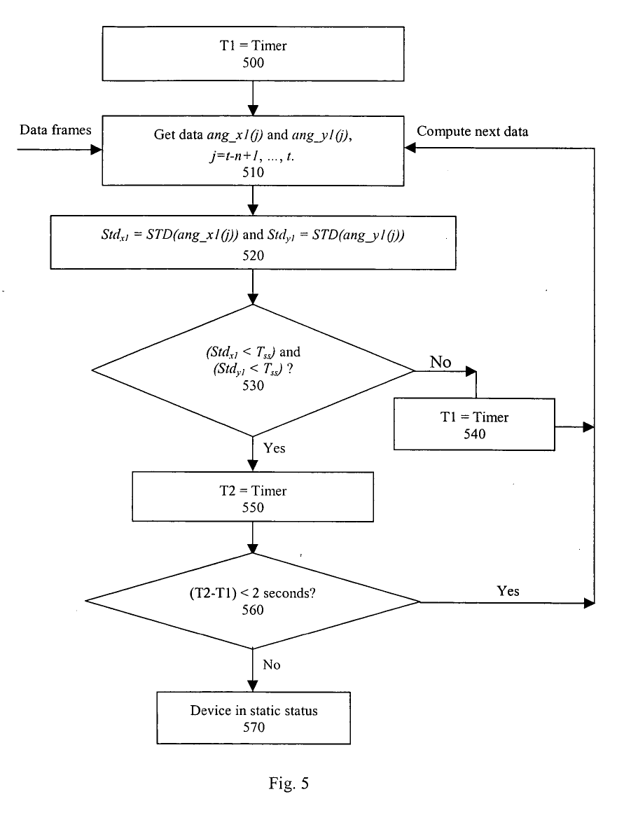

In step 400, the driver software 80 reads a data block having one or more data frames from the data buffer to determine whether the sensor unit 10 is in static status. In step 410, the driver software 80 determines whether the sensor unit 10 is in static status. To determine whether the sensor unit 10 is in a static state, namely, when the user holds the golf club 70 relatively still prior to beginning to swing, the driver software 80 reads the acceleration and angle data from sensor unit 10 in the data buffer 10 to determine if the acceleration and angle data indicate movement below a certain threshold. This determination is described in greater detail below with reference to FIG. 5. If it is determined that the sensor unit 10 is not in static status, in step 410, the driver software 80 reads the next data block from the sensor unit 10 in step 400, waiting for the club 70 to be in static state.

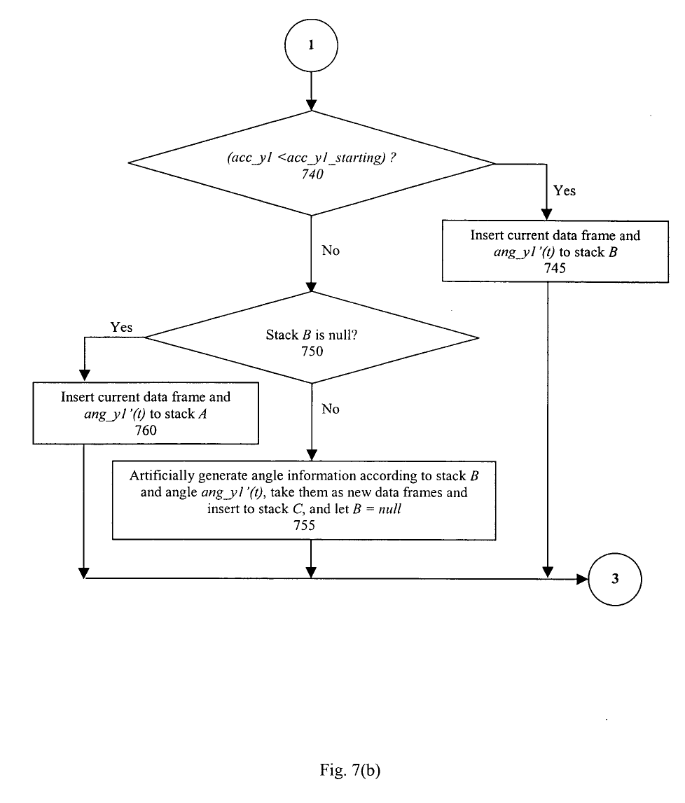

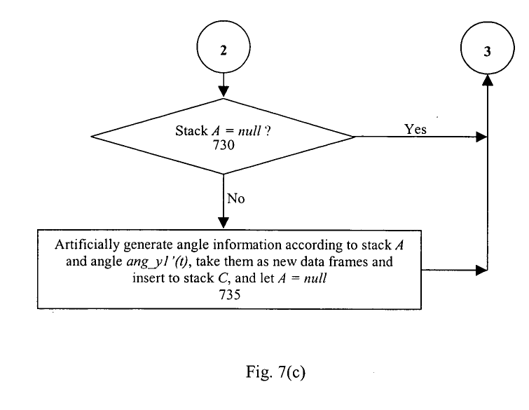

If it is determined that the sensor unit 10 is in static status, the driver software 80 reads the data block, in step 420, to determine the acceleration data and angle data representative of the user's swing. In step 430, the driver software 80 uses window filtering to smooth the current data frame in the data block to filter out the noise resulting from unintentional movement of the golf club 70. In step 440, the driver software 80 converts the filtered acceleration data and angle data to mouse controller input data by computing the incremental mouse controller movement distance between the current data frame in the data block and the prior data frame in the data block. As described in greater detail below with reference to FIG. 7, the driver software 80 translates actual club movement, as measured by the received acceleration and angle data into mouse controller movement data.

In step 450, the mouse controller input data that is representative of the user's swing is received, as if directly from the mouse controller, by the video game software running on the user station 90 to control the movement of a game character in the video game running. In step 460, the driver software 80 determines whether point of impact has been reached. The driver software 80 determines whether the point of impact has been reached by utilizing delayed processing. Following the determination that the sensor unit 10 is in static status, the driver software 80 processes data frames in real-time or substantially real-time until the software driver 80 detects a reading of valid angle data following the acceleration due to the backswing of the club 70 by the user (This generally occurs as the user pauses at the top of his backswing prior to his downswing). Following recognition of valid angle data, as described herein, the driver software 80 continues to process the data frame, but in a delayed format, so that the driver software 80 can determine whether the highest acceleration for the swing has been reached, signaling the point of impact. The delay in processing should be as long as necessary to ensure that the highest acceleration had been reached and the acceleration is now decreasing due to the follow through of the golf swing. If driver software 80 determines that point of impact has been reached, in step 460, then driver software 80 continues to read data frames until angle data shows for the golf club 70 is equal to 20 degrees past the angle data at the point of impact in step 470, and then there is no additional processing of data for current swing and the subprocess ends in step 480. The driver software 80 may be configured to continue reading data frames until the angle data for the golf club 70 is greater than or less than 20 degrees. If driver software 80 determines that point of impact has not been reached, in step 460, then the driver software 80 determines whether the current data block includes another data frame that has not been processed for the user's swing, in step 490. If it is determined that all data frames have not been processed for the current data block in step 490, then driver software 80 reads the next data frame and return to step 430. If it is determined that all data frames have been processed for the current data block in step 490, then process returns to step 420 and driver software 80 reads the next data block.

Having generally described the process of converting swing data to mouse data in the present embodiment, each step in the process will now be described in greater detail.

The process for reading a data block from the sensor unit 10 according to one embodiment of the present invention will now be described. The driver software 80 reads a data block having one or more data frames from the sensor unit 10 to determine whether the sensor unit 10 is in static status. A timer of the driver software 80 is set to allow the driver software 80 to read a data block from the data buffer of the serial port of the user station 90. The timer's interval is preferably set at 200 ms. The data buffer of the driver software 80 for the serial port communication is preferably large enough for 100 data frames to be read by the driver software 80. In alternate embodiments, the timer's interval may be greater or less than 200 ms, and the data buffer may allow for greater or less than 100 data frames to be read by the driver software 80 at one time, as appropriate for the particular application.

The process for determining whether the sensor unit 10 is in static status according to one embodiment of the present invention will now be described in greater detail. The driver software 80 determines whether the sensor unit 10 is in static status. The sensor unit 10 is considered to be in static status when the golf club 70 is being held at a relatively steady position, in the present golf embodiment, at the bottom (prior to swing) or top (pause following backswing) of the user's swing. If the driver software 80 determines that the sensor unit 10 is in static status, the sensor unit 10 is prepared to measure the acceleration data and angle data of the user's next swing. The driver software 80 embodies appropriate algorithms to be used to convert the acceleration and angle data to mouse controller input data, as described herein and one or more audible or other perceptible signals, such as beeps, lights, or voice commands, will occur to alert the user that he or she may now swing the golf club 70.

The number of audible signals depends on the type of swing mode that has been set by the user prior to his or her swing. There are three swing modes that may be selected by the user: (1) full swing; (2) chipping; and (3) putting. The number of audible signals for each type of swing mode are one, two, and three, respectively. In alternate embodiments, other manners of alerting the user as to the status or mode of the golf swing may be utilized, such as a voice command or visual signal (e.g. a group of one, two and three flashes repeated) displayed on the user station 90. The driver software 80 is configured to process the acceleration data and angle data received from the sensor unit 10 using a different method depending upon the type of swing mode that has been set by the user prior to his or her swing. A detailed explanation of the methods employed to process the acceleration data and angle data received from the sensor unit 10 and are described herein.

If the driver software 80 determines that the sensor unit 10 is not in static status from the current data block, the driver software 80 will read the next data block, continuously repeating the process until the driver software 80 determines the sensor unit 10 to be in static status. During this determination of whether the driver software 80 is in static status, no acceleration data, nor angle data received from the sensor unit 10 is converted into mouse controller input data by the driver software 80.

An exemplary process for determining whether the sensor unit 10 is in static status is shown in FIG. 5. In this example, t is the current time; ang_x1(i) and ang_y1(i) represent the angle data at time (i) of the x axis of the first accelerometer 20 and the y axis of the first accelerometer 20 (where i=1, 2, 3, . . . t); n is the window filter size; Tₛₛ is the threshold for STD filtering; and STD( ) is a function of standard deviation. At each time, t, the driver software 80 determines whether the sensor unit 10 is in static status, by reading the acceleration and angle data from the sensor unit 10 to determine if the acceleration and angle data indicate movement below a certain threshold, using the following method. In step 500, the timer is set (T1=Timer). In step 510, the driver software 80 reads the data frames in the current data block and obtains the data ang_{—x}1(j) and ang_y1(j), where j=t−n+1, . . . , t. By doing so, the driver software 80 acquires the data in the current window to be filtered. In step 520, the software 80 determines the standard deviation for each axis according to the equations: Stdₓ₁=STD(ang_x1(j)) and Std_{y1}=STD(ang_y1(j))). In step 530, the software 80 determines whether the standard deviation for each axis (Stdₓ₁, Std_{y1}) is below the defined threshold Tₛₛ ((Stdₓ₁<Tₛₛ) and (Std_{y1}<Tₛₛ)). If the logic statement in step 530 is false, namely the change in movement of the club 70 in either axis is above the threshold, then the timer is essentially reset with the current time (T1=Timer) in step 540, and the process continues to read the next data block in step 510. If the logic statement in step 530 is true, namely that the change in movement during the period is less than the threshold, then the current time is noted (T2=Timer) in step 550. In step 560, determine whether the differences in time between the beginning of the readings and the end of the readings is less than a certain threshold, for example, two seconds (i.e., (T2-T1)<2 seconds). The time period of two seconds represents the amount of time that change in movement must be continuously below the threshold in order for the sensor unit 10 to be considered in static status. In alternate embodiment, the time period can be greater than or less than two seconds. If the logic statement in step 560 is true, then the next data block is read in step 510. If the logic statement in step 560 is false, then the sensor unit 10 is in static status in step 570.

When the driver software 80 determines that the sensor unit 10 is in static status, the sensor unit 10 is prepared to measure the acceleration data and angle data of the user's swing and an audible signal (based on the type of swing mode) will alert the user that he or she may now swing the golf club 70. As the user swings the golf club 70, a data block having one or more data frames of acceleration data and angle data is measured by the sensor unit 10 and processed by the driver software 80 to convert the acceleration data and angle data representative of the user's swing into mouse controller input data via the following processes in the present embodiment.

The process for smoothing the current data frame using window filtering will now be described in greater detail according to one embodiment of the present invention. The acceleration data and angle data read by the driver software 80 from the sensor unit 10 often has noise (jitter) associated therewith that is the result of unintentional movement of the golf club 70. The reasons for such noise may include the shaking of a person's hands, the sensitivity of the accelerometers 20 in the sensor unit 10, and the like. It is desirable to filter out this unintentional noise in order to obtain a more accurate representation of the acceleration and angle data to be processed by the driver software 80.

In the present embodiment, the driver software 80 applies a non-linear technique is applied to filter out noise and smooth the acceleration and angle data in the data frame using a sliding window to a data sequence, such as the exemplary process shown below. In the following example, t is the current time; f(i) is acceleration and/or angle data at time (i) (where i=1,2,3, . . . t); n is the filter size; p and y are temporary storage variables; f(t−n to t) represents raw angle or acceleration data; and f(t)=transformed angle or acceleration data. At each time, t, the data is processed as follows:

$$1 \text{)} Let p ( 0 to n ) = f ( t \text{-} n to t ) ;$$

$$2 \text{)} Compute y ( a ) = p ( a ) - p ( a \text{-} 1 ) , \\ where a = 1 , 2 , 3 , … n ;$$

$$3 \text{)} Let s = {\sum }_{a = 1}^{t} y ( a ) and {s}_{1} = {\sum }_{a = 1}^{t} \vert y ( a ) \vert ; and$$

$$4 \text{)} if \sim ( s = {s}_{1} or s = \text{-} {s}_{1} ) then f ( t ) = f ( t \text{-} 1 ) .$$

It is to be understood that the filtering is optional and that other filtering techniques may be used.

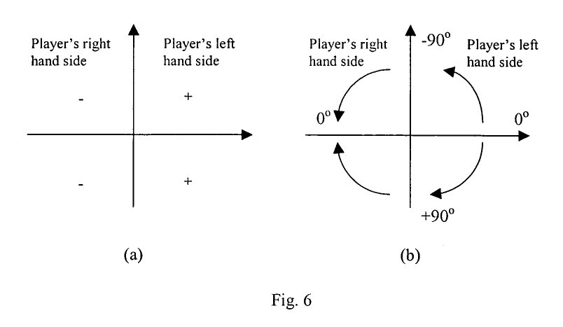

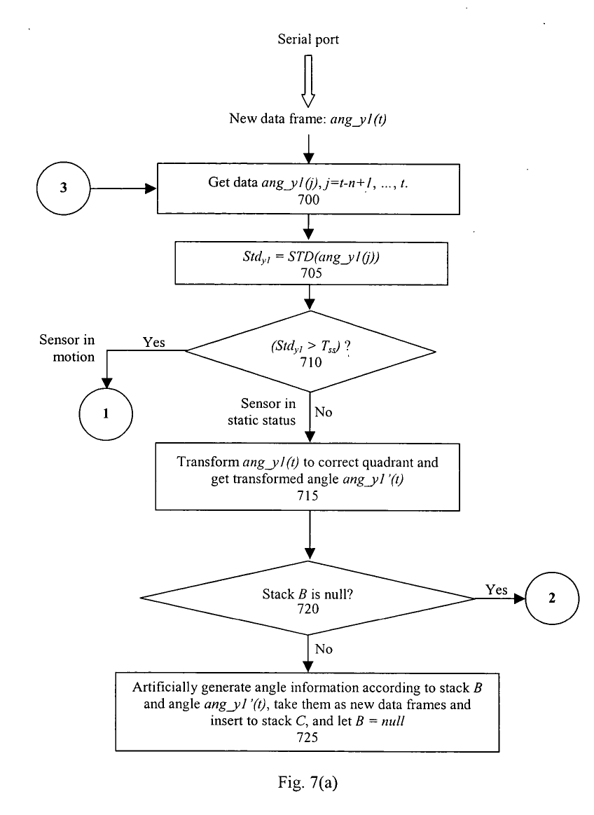

The process for transformation of the unfiltered angle data into filtered angle data according to one embodiment of the present invention will now be described. The particular accelerometers 20 used in the present embodiment measure the angle position in a range of 0 to +/−90 degrees with respect to the vertical direction. Therefore, certain readings may be in one of two quadrants, as illustrated in FIG. 6(b). To more accurately measure the angle position of the golf club 70 and simulate the user's golf club swing, the proper quadrant of the golf club 70 must be determined. The process described below constitutes the method used by the driver software 80 in the present embodiment to determine the proper quadrant of the golf club 70 and calculate the proper angle data to simulate the user's swing.

As described herein, the acceleration data of the golf club swing is measured directly by the accelerometers 20. The first four values in each data frame constitute the acceleration of the golf club swing in the x and y axes of the first accelerometer 20 and the x and y axes of the second accelerometer 30 (acc_x1, acc_y1, acc_x2, acc_y2). The angle data in each data frame is computed by the sensor firmware 65 using PWM data. The last four values in each data frame constitute the angle of the golf club swing in the x and y axes of the first accelerometer 20 and the x and y axes of the second accelerometer 30 (ang_x1, ang_y1, ang_x2, ang_y2).

In the present embodiment, the golf club 70 may be positioned in one of four quadrants (90° to 0°, 0° to −90°, −90° to −180°, or −180° to −270°, as pictured in FIG. 6(c). According to the present exemplary depiction, if the golf club 70 is positioned at approximately −180 degrees (i.e., the club 70 being horizontal, parallel to the ground), the user is in full swing position; if the golf club 70 is positioned between −180 degrees and −90 degrees, the user is in ¾ swing position; if the golf club 70 is positioned at approximately −90 degrees, the user is in ½ swing position; and if the golf club 70 is positioned at approximately 0 degrees, the user is in ¼ swing position.

FIG. 6(a) shows the sign changes of ang_x1 and FIG. 6(b) shows the angle changes of ang_y1 in the four quadrants. Compared with other angle data, ang_y1 is relatively stable and not so sensitive to twist. For ang_x1, because of possible twists of the club 70 by players, its value changes even when the sensor unit 10 is in the same position. However, the sign of its value does not change if the accelerometer 20 is not in fast motion. As shown in FIGS. 6(a) and 6(b), the sign of ang_x1 is positive, ‘+’ when the club 70 is swung to the player's left hand side, otherwise, the sign of ang_x1 is negative ‘−’. For ang_y1, if the sensor unit 10 is not in fast motion, its value changes from 90 degree to −90 degree when the position of the sensor unit 10 changes from the bottom to the top (from both sides, left hand side and right hand side). In the present embodiment, in order to map the angle data ang_y1 to the correct quadrants, the value of ang_y1 is defined based on the swing direction, backswing or downswing. FIG. 6(c) shows the value of ang_y1 in different positions based on the backswing direction and FIG. 6(d) shows the value of ang_y1 in different positions based on the downswing direction. The change of ang_y1 determines the mouse controller movement distance. However, the speed of club 70 and distance the golf ball will travel depends on how the particular video game interprets such mouse controller movement.

It has been determined that, in the present embodiment, the angle data is more reliable when the sensor unit 10 is in static status, as opposed to when the sensor unit 10 is in motion, where the angle data is inaccurate. Therefore, the conversion from the golf club swing data (acceleration and angle data) to mouse controller input data will be delayed. In order to improve this conversion rate to substantially real-time, the exemplary process, shown in FIGS. 7(a)-7(c), is used to transform the unfiltered angle data into filtered angle data. In this example, t is the current time; ang_y1(i) represents the angle data in the y axis of the first accelerometer 20 (i=1,2,3, . . . t); acc_y1(i) represents the acceleration data in the y axis of the first accelerometer 20 (i=1,2,3, . . . t); n is the filter size; Tₛₛ is the threshold for STD filtering; Stack is a data structure for temporarily storing angle data during the transformation process; and STD( ) is a function of standard deviation.

In step 700, the driver software 80 reads the current data frame and obtains the angle data in the y axis at time j, ang_y1(j), where j=t−n+1, . . . , t. In step 705, the software 80 calculates the standard deviation over the filter time period, Std_{y1}=STD(ang_y1(j)). Having determined the standard deviation, in step 710, the software 80 determines whether the standard deviation is greater than the threshold value (i.e., whether Std_{y1}>Tₛₛ). If the standard deviation is greater than the threshold, then the sensor unit 10 is deemed to be in motion and the process continues with step 740.

If the standard deviation is equal to or less than the threshold, then the sensor unit 10 is deemed to be in static status and the process continues with the software 80 transforming the angle data, ang_y1(t), into transformed angle data, ang_y1(t), to reflect the correct quadrant of the club 70 in step 715. Because the particular accelerometers 20 measure the angle position in a range of 0 to +/−90 degrees, certain readings may be in one of two quadrants, as illustrated in FIG. 6(b). This process determines the proper quadrant and transforms the angle data, as received from the accelerometers 20, into angle data reflective of the appropriate quadrant. For example, angle data of −70 could be in either the bottom right quadrant or the upper right quadrant, as illustrated in FIG. 6(b).

In step 720, the software 80 determines whether Stack B is null, or empty. If stack B is not null, then, in step 725 the driver software 80 artificially generates angle information according to Stack B and the transformed angle, ang_y1′(t), takes them as new data frames and insert them into Stack C; Stack B remains null. If Stack B is null, then the driver software 80 determines whether Stack A is null, in step 730.

If Stack A is not null, then, in step 730, then the driver software 80 artificially generates angle information according to Stack A and the transformed angle, ang_y1′(t), takes them as new data frames and insert them into stack C; Stack A remains null. If Stack A is null, then the process returns to step 700 to read a new data frame.

Continuing with step 740, the driver software 80 determines whether the current acceleration in the y axis is less than the acceleration at the beginning of the time period, as stored by the driver software 80 (i.e., acc_y1<acc_y1_starting). If the current acceleration is less than the starting acceleration, then, in step 745, the software 80 inserts the current data frame and transformed angle data, ang_y1′(t), into Stack B, and the process returns to step 700 to read new data frame.

If the current acceleration data is not less than the starting data, then the driver software 80 determines whether Stack B is null in step 750. If Stack B is not null in step 750, then, in step 755, the driver software 80 artificially generates angle information according to Stack B and the transformed angle, ang_y1′(t), takes them as new data frame, inserts them into Stack C, and lets Stack B be null. The process then returns to step 700 to read new data frame. If Stack B is null in step 750, then the driver software 80 inserts current frame data and transformed angle data, ang_y1′(t), into Stack A in step 760, and then the process returns to step 700 to read new data frame.

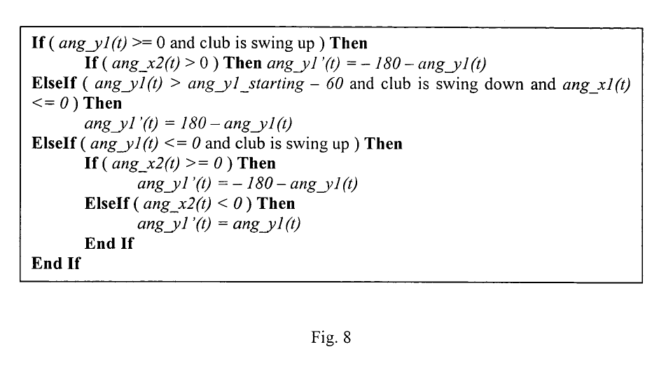

The process for transforming the value of raw angle data into correct quadrant angle data according to one embodiment of the present invention will now be described with reference to the exemplary pseudocode shown in FIG. 8. As illustrated, the driver software 80 determines whether the angle data in the y1 axis is greater than or equal to zero and whether the club 70 is in backswing. The driver software 80 determines whether the club 70 is in backswing by using angle change. If these conditions are satisfied, then if the measured angle data in the x2 axis is greater than zero, the transformed angle data in the y1 axis equals −180 less the actual angle data in the y1 axis. The result is transforming a reading that could be in either the player's left top quadrant or player's left bottom quadrant into the player's left bottom quadrant. Similarly, if the angle data in the y1 axis is greater than the starting value minus 60 degrees, the club swing is determined to be downswing (i.e., moving towards impact) and the x1 angle data is less than or equal to zero, thereby indicating that the club 70 is in the player's left quadrant, then the transformed y1 angle data equals 180 less the actual angle value. The other transformed angle values are calculated as indicated in the FIG. 8.

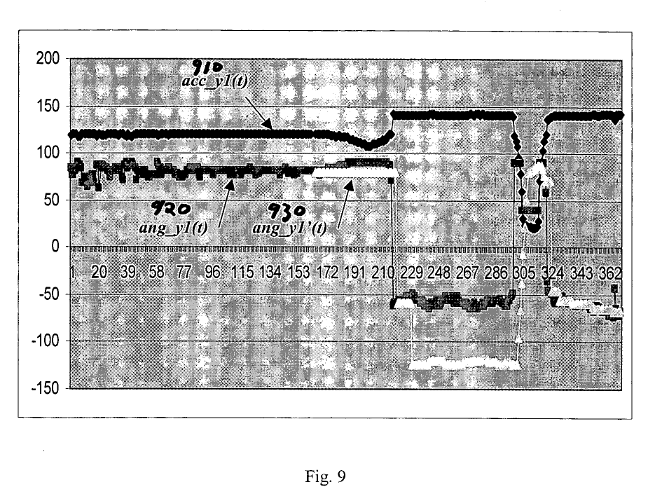

An example of raw angle data, transformed angle data, and raw acceleration data for a three-quarter swing according to one embodiment of the present invention will now be described with reference to the illustrative graph in FIG. 9. The values displayed vertically along the graph represent acceleration values measured in mg (where 1 mg equals one thousandth of the gravitational constant, g). The values displayed horizontally along the graph represent the date frame number within the data block for a swing acc_y1(t) at each data frame is displayed as line 910, ang_y1(t) at each data frame is displayed as line 920, and ang_y1′(t) at each data frame is displayed as line 930. As seen in FIG. 9, from data frame 1-172, acc_y1(t) remains constant at approximately 120 mg (threshold value), which represents the golf club 70 remaining in static position prior to the swing. From data frame 173-210, acc_y1(t) decreases slightly below the static position threshold value 120 mg to approximately 100 mg and then returns to 120 mg, which represents a small increase in acceleration resulting from the back swing of the golf club 70. From data frame 211-300, acc_y1(t) remains constant at approximately 140 mg, which also represents the golf club 70 remaining in static position as the user pauses at the top of their swing. From data frame 301-324, acc_y1(t) decreases drastically below 120 mg to approximately 20 mg and then returns to static position at 140 mg, which represents a large increase in acceleration resulting from the user's swing of the golf club 70 and then the follow through. The lowest point of the decrease, at approximately data frame 310, represents the highest acceleration of the swing and the simulated point of impact of the golf ball. From data frame 325-362, acc_y1(t) remains constant at approximately 140 mg, which represents the golf club 70 paused at the end of the follow through by the user.

As seen in FIG. 9, from data frame 1-165, ang_y1(t) fluctuates slightly as a result of unintentional movement of the golf club 70. At data frame 166, the software driver 80 recognizes that the golf club 70 is in static position as the unintentional movement lessens and begins mapping the ang_y1(t) data to the correct quadrant to obtain ang_y1′(t) as described in FIG. 8. From data frame 166-211, ang_y1′(t) remains constant while the golf club 70 remains in static position prior to the swing and during the back swing. At data frame 212, ang_y1′(t) drops significantly representing the filtering algorithm calculating the quadrant that the club 70 is in using the valid angle data. After this calculation, the algorithm determines that the club 70 is actually in the ¾ swing quadrant and the filtered data is adjusted according to this calculation, from data frames 229-300. From data frames 301-324, acc_y1(t) increases drastically representing the change in quadrant as the user swings the club 70, and then decreases drastically representing the change in quadrant as the user follows through after swinging the club 70.

The process for transforming the angle change of a golf club swing into mouse controller movement distance according to one embodiment of the present invention will now be described.

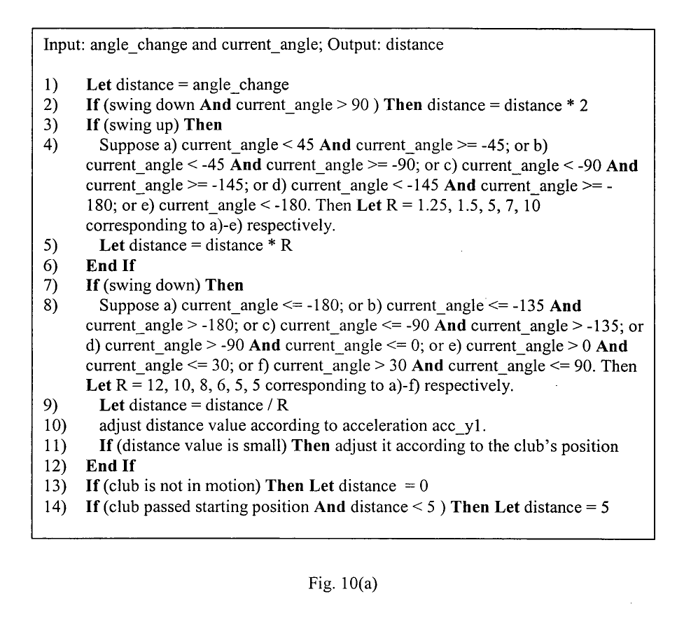

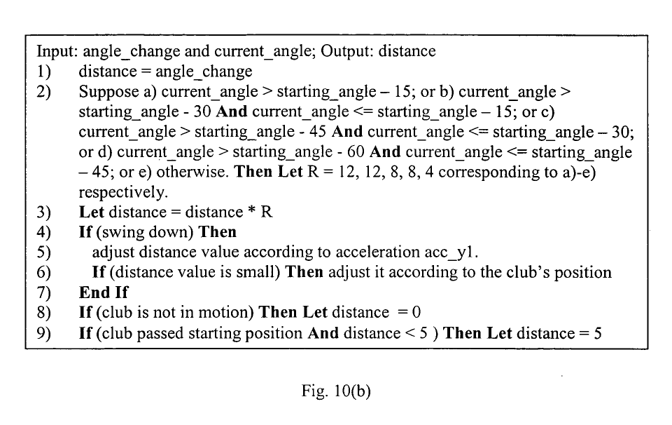

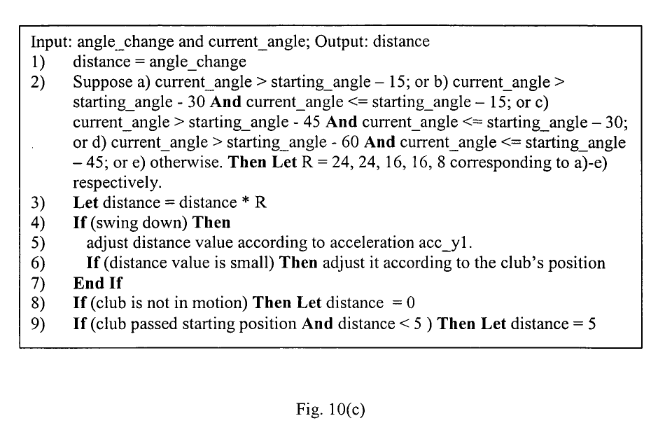

Once raw angle, ang_y1(t), is transformed into correct quadrant angle, ang_y1′(t), the mouse controller movement distance can be computed. The following exemplary processes for transforming (a) full swing; (b) chipping; and (c) putting into mouse controller movement distance are described respectively with reference to the pseudocode in FIGS. 10(a)-10(c).

In these examples, t is current time; and ang_y1′(t) is angle data in the current data frame of the y axis of the first accelerometer 20; ang_y1′(t−1) is angle data in the prior data frame of the y axis of the first accelerometer 20. The mouse controller movement distance between ang_y1 ′(t) and ang_y1′(t−1) may be mapped based on the swing mode and the position of the golf club 70.

An additional process for transforming the angle change of a golf club putt into mouse controller movement distance according to one embodiment of the present invention will now be described.

A user has to move the mouse a relatively long distance to drive in putting mode for certain video games. However, a user usually moves the club 70 in a short distance for putting. In order to let the user feel more real, in putting mode, it is necessary to move a long distance for a small angle change. The angle changes can be mapped to mouse movement distance directly, as for full swing mode and chipping mode. However, because of the noise in raw angle data, when the player holds the club 70 in static position, there is no guarantee that the angle data has not changed after the window filtering technique, as described earlier, is applied. The following pseudocode represents one possible way to overcome this problem, in which the distance of club movement is equal to the angle change of the club 70 multiplied by a conversion variable, R, which is based on the difference between the current angle and starting angle. In the following pseudocode, the variable, distance, represents mouse movement distance, and the unit of measurement of distance is pixels. The code also determines whether to ignore nominal movements (lines 2-5) so as not to inadvertently hit the ball. Furthermore, if the club 70 passes the starting position, the code assumes the user intended to hit the ball (in line 7) and ensure a minimum distance, for example, five pixels.

Input: angle_change and current_angle; Output: distance

1) distance angle_change
2) For last PUTT_DOWN_STABLE_LENGTH frames of angle data (ang_y1), Let k1=the number of angle changes that are greater than 0 and less than 10.
3) For last PUTT_UP_STABLE_LENGTH frames of angle data (ang_y1), Let k2=the number of angle changes that are less than 0 and greater than −10.
4) If (k1=1 Or k2=1) Then distance=0
5) Suppose a) current_angle>starting_angle−15; or b) current_angle>starting_angle−30
   And current_angle<=starting_angle−15; or c) current angle>starting angle−45
   And current_angle<=starting_angle−30; or d) current angle>starting_angle−60
   And current_angle<=starting angle−45; or e) otherwise.
   Then Let R=24, 24, 16, 16, 8 corresponding to a)-e) respectively.
6) Let distance=distance*R
7) If (club passed starting position And distance<5) Then Let distance=5.

It is to be understood that modifications may be made to the code. For example, the values of R are merely exemplary, as are the ranges of angle data corresponding to such values.

Where the user station 90 is a PC operating Windows based operating system, a Windows API “sendInput” is used to move mouse automatically. The declaration is: Declare Function SendInput Lib “user32.dll” (ByVal nInputs as Long, pInputs As INPUT_TYPE, ByVal cbSize as Long) As Long. The detailed explanation of this API could be found in Microsoft's SDK document, which can be found at http://www.partware.com/ebooks/API/ref/s/sendinput.html.

The mouse controller movement distance computed by the driver software 80 may need to be implemented in multiple incremental movements instead of a single large mouse controller movement to ensure proper simulation of the user's swing. For example, where the acceleration data and angle data representative of the user's swing is converted into a mouse controller movement distance of more than 50 pixels, such a large mouse controller movement distance would not be accurately understood by a video game, such as LINKS2003. Where the mouse controller movement distance computed by the driver software 80 would be too large to be accurately understood by the video game, the mouse controller movement distance is represented by several mouse movement steps. For each different swing mode, the length of the mouse movement step is different. Between every two simulated mouse controller movement s, the driver software 80 should wait some time to allow the operating system of the user station 90 to respond to the last mouse controller movement command. Otherwise, a new SendInput will be triggered and it will stop last mouse controller movement, which let the club 70 in LINKS 2003 not correspond to the real swing. Also, if a long wait-time is used, the swing in LINKS 2003 will be delayed. In our tests, we use 10 milliseconds for wait-time in our software for both backswing and downswing.

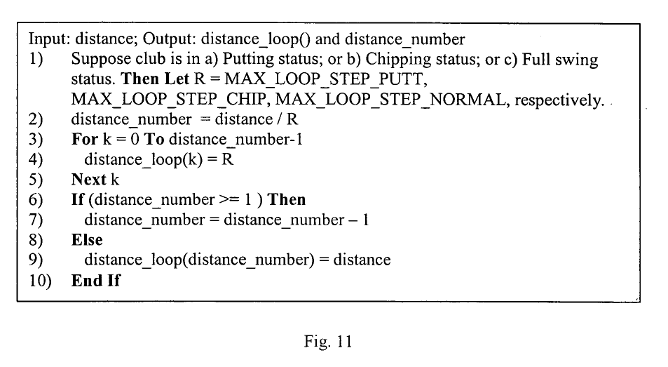

An exemplary process for converting exceptionally large swing data into mouse controller movement data that can be understood by a video game according to one embodiment of the present invention will now be described below with reference to the pseudocode FIG. 11. The acceleration and angle data received from the sensor unit 10 may be converted into mouse controller movement data that is too large for a particular video game to handle at once. Therefore it is necessary to break up the large mouse controller movement data from one large movement to multiple smaller movements. For example a mouse movement of 100 pixels may need to be broken into increments of 25 pixels for a putt or chip, and increments of 50 pixels for a full swing.

Input: distance; Output: distance_loop( ) and distance_number

1) If club is in a) Putting status; or b) Chipping status; or c) Full swing status, then Let R=MAX_LOOP_STEP_PUTT, MAX_LOOP_STEP_CHIP, MAX_LOOP_STEP_NORMAL, respectively.
2) distance_number=distance/R
3) For k=0 To distance_number−1
4) distance_loop(k)=R
5) Next k
6) If (distance_number>=1) Then
7) distance_number=distance number−1
8) Else
9) distance_loop(distance_number)=distance
10) End If.

In further embodiments, the software driver 80 further accounts for club face position, namely open, closed, or square, to determine the angle or direction at which the golf ball would travel following the point of impact. In certain embodiments, each club face position is assigned a particular range of swing speed. When a user swings the club 70, a club face position for the swing is determined based upon the range that encompasses the user's swing speed. In alternate embodiments, the club face direction is determined by an examination of the acceleration components transverse to the direction of motion of the club.

More specifically, in one embodiment, the determination as to the position of the club face is based on the speed of the user's swing at the point of impact: an average speed swing results in a square club face position; a slower than normal swing results in a closed club face; and a faster than normal swing results in an open club face. To determine what is normal for any given golfer/user, the software 80 is trained by the user taking several practice swings. The range of speeds for these practice swings are noted in memory and divided into three ranges, one for each of the three club face positions. In certain embodiments, once the user's swing has been calibrated, the speed of the actual swing is determined as the average of the speed at the point of impact and during two frames immediately following impact, although the value may be taken at fewer or more points in the swing (i.e., frames). For example, using the Analog Devices Inc. ADXL202 dual axis accelerometer, certain golfers would have the following ranges and club face positions for a full swing: if ang_y1 is in the high range of 148-180 mg the club head is in open club face position, if ang_y1 is the middle range of 143-147 mg the club head is in square club face position, and if ang_y1 is in the low range of 120-142 mg the club head is in the closed club face position (mg=one thousandth of the gravitational constant, g). For a chip or putt, if ang_y1 is in the high range of 131-165 mg the club head is in open club face position, if ang_y1 is the middle range of 126-130 mg the club head is in square club face position, and if ang_y1 is in the low range of 90-125 mg the club head is in the closed club face position. It should be understood that any number of positions may be deemed relevant, including fewer than three or more than three (e.g., different degrees of open or closed position) and the range of speeds can be correspondingly divided into fewer or more subranges. Furthermore, the subranges associated with the positions can be, but need not be, uniform in size.

In alternate embodiments of the present invention, rate gyros may be used as additional sensors 20 to extract rotational motion, in addition to translational motion, to allow for six degrees of freedom.

Those skilled in the art will recognize that the method and system of the present invention has many applications, may be implemented in many manners and, as such, is not to be limited by the foregoing exemplary embodiments and examples. Additionally, the functionality of the components of the foregoing embodiments may be implemented in different manners. Further, it is to be understood that the steps in the foregoing embodiments may be performed in any suitable order, combined into fewer steps or divided into more steps. Thus, the scope of the present invention covers conventionally known and future developed variations and modifications to the system components described herein, as would be understood by those skilled in the art.

1. A system for use with a computer application configured to respond to first input device data from a first input device, the first input device having a first format, the system comprising:
a second input device, different than the first input device, the second input device including one or more sensors configured to measure movement of an object and creating second input device data representative of the movement of the object, the second input device data having a second format different than the first format; and
a processor configured to convert the second input device data into simulated first input device data, the simulated first input device data having the first format, the processor further configured to provide the simulated first input device data to the computer application, thereby simulating the first input device with the second input device.

2. The system of claim 1, further comprising a transmitter configured to communicate the second input device data to the processor.

3. The system of claim 2, wherein the transmitter is a transceiver configured to allow two-way communication of data between the second input device and the processor.

4. The system of claim 3, further comprising sensor firmware configured to recognize that data is being sent from the processor to the second input device.

5. The system of claim 1, wherein the computer application is a video game.

6. The system of claim 1, wherein the first input device is one of the following devices: a mouse, a joystick, or a keyboard, and the first input device data is mouse controller input data, joystick controller input data, or keyboard input data.

7. The system of claim 1, wherein the object is a golf club and the second input device is attached to the golf club.

8. The system of claim 1, wherein the object is a system user's arm and the second input device is attached to the system user's arm.

9. The system of claim 1, wherein the one or more sensors are accelerometers configured to measure the acceleration and angle of the object in one or more directions and the second input device data is representative of the acceleration and angle of the object.

10. The system of claim 9, further comprising sensor firmware, wherein the acceleration of the object is measured directly from the one or more accelerometers and the angle of the object is computed by the sensor firmware.

11. The system of claim 10, further comprising a transmitter configured to communicate the second input device data to the processor, wherein the second input device additionally sends calibration data for the accelerometers to the processor to facilitate calculation of the angle of the object.

12. The system of claim 11, wherein the transmitter is a transceiver configured to allow two-way communication of data between the second input device and the processor, and wherein data is sent from the processor to the second input device requesting the calibration data.

13. The system of claim 1, further comprising a sensor processor configured to assemble the second input device data into data frames to communicate to the processor configured to convert the second input device data.

14. The system of claim 13, wherein each data frame includes acceleration and angle measurements for the object.

15. The system of claim 1, wherein the processor further comprises driver software, configured to convert the second input device data into simulated first input device data.

16. The system of claim 1, wherein the one or more sensors indicate multiple potential positions of the object at a given time and the processor determines in which of multiple potential positions the object is located.

17. The system of claim 16, wherein the object is a golf club and the multiple potential positions include potential locations of the golf club in multiple quadrants of 90 degrees.

18. The system of claim 1, wherein the processor is configured to receive a certain amount of first input device data at a given time and the processor divides the simulated first input device data into multiple smaller portions of the certain amount of the simulated first input device data to provide to the computer application.

19. The system of claim 1, wherein the processor is configured to have a first mode and a second mode, wherein in the first mode a first movement results in a first simulated input resulting in a first movement of a game character, and wherein in the second mode the first movement results in a second simulated input resulting in a second movement of the game character.

20. A system for converting movement of an object from a first format into input device data of a second format that a computer application is configured to receive, the system comprising
a sensor unit including:
one or more sensors configured to measure movement of the object in one or more directions and create a signal representative of the movement of the object in a first format; and
a transmitter configured to communicate the signal; and
a user station having driver software configured to receive the signal, convert the signal into simulated input device data having the second format, and provide the simulated input device data to the computer application.

21. The system of claim 20, wherein the transmitter is a transceiver configured to allow two-way communication of data between the sensor unit and the user station.

22. The system of claim 21, wherein the sensor unit further includes sensor firmware configured to recognize that data is being sent from the user station to the sensor unit.

23. The system of claim 20, wherein the computer application is a video game.

24. The system of claim 20, wherein the input device is a mouse, and the input device data is mouse controller input data.

25. The system of claim 20, wherein the object is a golf club and the sensor unit attaches to the golf club.

26. The system of claim 20, wherein the object is a system user's arm and the sensor unit attaches to the system user's arm.

27. The system of claim 20, wherein the one or more sensors are accelerometers configured to measure the acceleration and angle of the object in one or more directions and the signal is representative of the acceleration and angle of the object.

28. The system of claim 27, wherein the sensor unit further includes sensor firmware, wherein the acceleration of the object is measured directly from the one or more accelerometers and the angle of the object is computed by the sensor firmware.

29. The system of claim 27, wherein the sensor unit additionally sends calibration data for the accelerometers to the driver software to facilitate calculation of the angle of the object.

30. The system of claim 29, wherein the transmitter is a transceiver configured to allow two-way communication of data between the sensor unit and the user station, and wherein data is sent from the driver software to the sensor unit requesting the calibration data.

31. The system of claim 20, wherein the sensor unit further includes a sensor processor configured to assemble second input device data into data frames to communicate to the processor.

32. The system of claim 31, wherein each data frame includes acceleration and angle measurements for the object.

33. The system of claim 20, wherein the one or more sensors indicate multiple potential positions of the object at a given time and the driver software determines in which of multiple potential positions the object is located.

34. The system of claim 33, wherein the object is a golf club and the multiple potential positions include potential locations of the golf club in multiple quadrants of 90 degrees.

35. The system of claim 20, wherein the driver software is configured to receive a certain amount of input device data at a given time and the driver software divides the simulated input device data into multiple smaller portions of the certain amount of the simulated input device data to provide to the computer application.

36. A method of providing input to a computer application configured to receive first input device data having a first format, the method comprising:
measuring movement of an object in one or more directions;
creating second input device data representative of the movement of the object, the second input device data having a second format different than the first format;
converting the second input device data into simulated first input device data, the simulated first input device data having the first format; and
providing the simulated first input device data to the computer application, thereby simulating the first input device with the second input device.

37. The method of claim 36, wherein the measuring includes measuring the acceleration and angle of the object in one or more directions and the creating includes creating second input device data representative of the acceleration and angle of the object.

38. The method of claim 37, wherein the measuring further includes computing the angle of the object using sensor firmware.

39. The method of claim 38, wherein the creating further includes assembling the measured acceleration and angle data into data frames.

40. The method of claim 39, wherein each data frame includes acceleration and angle measurements for the object.

41. The method of claim 36, wherein the computer application is a video game.

42. The method of claim 36, wherein the first input device data is mouse controller input data.

43. The method of claim 36, wherein the object is a golf club and the second input device data is representative of the movement of the golf club.

44. The method of claim 36, further comprising determining in which of multiple potential positions the object is located at a given time.

45. The method of claim 44, wherein the object is a golf club and the multiple potential positions include potential locations of the golf club in multiple quadrants of 90 degrees.

46. A system of providing input to a computer application configured to receive first input device data having a first format, the system comprising:
means for measuring movement of an object in one or more directions;
means for creating second input device data representative of the movement of the object, the second input device data having a second format different than the first format;
means for converting the second input device data into simulated first input device data, the simulated first input device data having the first format; and
means for providing the simulated first input device data to the computer application, thereby simulating the first input device with the second input device.

47. The system of claim 46, wherein the measuring means further comprises means for measuring the acceleration and angle of the object in one or more directions and the creating means further comprises means for creating second input device data representative of the acceleration and angle of the object.

48. The system of claim 47, further comprising means for computing the angle of the object.

49. The system of claim 48, further comprising means for assembling the measured acceleration and angle data into data frames.

50. The system of claim 49, wherein each data frame includes acceleration and angle measurements for the object.

51. The system of claim 46, wherein the computer application is a video game.

52. The system of claim 46, wherein the first input device data is mouse controller input data.

53. The system of claim 46, wherein the object is a golf club and the second input device data is representative of the movement of the golf club.

54. The system of claim 46, wherein the second input device data indicates multiple potential positions of the object at a given time, the system further comprising means for determining in which of the multiple potential positions the object is located at the given time.

55. The system of claim 54, wherein the object is a golf club and the multiple potential positions include potential locations of the golf club in multiple quadrants of 90 degrees, along a swing path, the determining based on the swing path.

57. A method for replicating first input device data of a first input device, the first input device data having a first format, to a computer application, to control movement of a graphical representation of an object, the method comprising:
measuring movement of the object with a second input device;
creating an electronic signal representative of the movement of the object, the electronic signal having a second format different from the first format;
translating the electronic signal into replicated first input device data having the first format; and
making the replicated first input device data available to the computer application, thereby replicating first input device data from the first input device with replicated first input device data from the second input device.

58. The method of claim 57, wherein the measuring includes measuring the acceleration and angle of the object in one or more directions and the creating includes creating an electronic signal representative of the acceleration and angle of the object.

59. The method of claim 58, wherein the measuring includes computing the angle of the object using sensor firmware.

60. The method of claim 58, wherein creating the electronic signal includes assembling the measured acceleration and angle data into data frames.

61. The method of claim 57, wherein the object is a golf club and the measuring includes measuring the movement of the golf club.

62. The method of claim 57, further comprising receiving data from the computer application.

63. The method of claim 57, wherein the first input device data is mouse controller input data, the mouse controller input data not representative of the movement of the object and wherein the replicated first input device data is replicated mouse controller data representative of the movement of the object.

64. The method of claim 57, wherein the electronic signal indicates multiple potential positions of the object at a given time, the method further comprising determining in which of the multiple potential positions the object is located at the given time.

65. The method of claim 64, wherein the object is a golf club and the multiple potential positions include potential locations of the golf club in multiple quadrants of 90 degrees, along a swing path, the determining based on the swing path.

66. A computer readable medium comprising code for configuring a processor to:
provide simulated input device data to a computer application, the computer application configured to control a graphical representation of an object in response to input device data; and
translate a signal into the simulated input device data, the signal representing physical movement of the object, the signal having a signal format incompatible with the computer application and the simulated input device data compatible with the computer application, thereby simulating the input device data.

67. The computer readable medium of claim 66, wherein the computer application is a video game, and the input device data includes mouse controller data, keyboard data, joystick data or game controller data, and the signal includes acceleration or angle data of the object.

68. The computer readable medium of claim 67, wherein the video game is a golf game and the object is a golf club.
